(19) United States
(12) Patent Application Publication
(10) Pub. No.: US 2026/0291545 A1
(43) Pub. Date: Sep. 24, 2026

(54) POWER AND DATA TRANSMISSION DEVICE

(71) Applicant: SAFRAN ELECTRONICS & DEFENSE, PARIS (FR)

(72) Inventors: François GUILLOT, MOISSY-CRAMAYEL (FR); Olivier MELINE, MOISSY-CRAMAYEL (FR); Bertrand LACOMBE, MOISSY-CRAMAYEL (FR); Laurent MARIANNE, MOISSY-CRAMAYEL (FR)

(21) Appl. No.: 19/478,384

(22) PCT Filed: Apr. 24, 2024
(86) PCT No.: PCT/EP2024/061245

§ 371 Date: Oct. 24, 2025

(30) Foreign Application Priority Data
Apr. 28, 2023 (FR) FR2304360

(51) Int. Cl. H04B 3/54; B64D 47/00; H02M 1/44; H02M 7/04

(52) U.S. Cl. CPC H04B 3/54; B64D 47/00; H02M 1/44; H02M 7/04

(57) ABSTRACT

A power and data transmission device, having a first circuit, a second circuit and a cable connecting the first circuit and the second circuit and having a first pair and a second pair of electrical conductors for transmitting a data signal and a power signal. The data signal is transmitted in differential mode in a first direction on the first pair of electrical conductors and in a second direction on the second pair of electrical conductors. The first circuit is designed to transmit, in differential mode, the power signal on a sinusoidal carrier using the common modes of the two pairs of conductors and the second circuit is designed to receive said power signal while maintaining, with respect to the cable, a real impedance equal to an iterative impedance of the cable.

The present invention relates to the field of data transmission between two remote electronic devices, and, in particular, two electronic devices on board a vehicle, such as an electronic control unit and a sensor.

### BACKGROUND OF THE INVENTION

In the aeronautical field, the need to ensure the maintenance of aircraft safety and performance has led to the increasing numbers of sensors present on aircraft and their dissemination throughout the structure and equipment of said aircraft.

The physical magnitudes measured by these sensors are varied, and it is necessary to limit, as much as possible, the intrusive impact(s) of installing them in the aircraft or its equipment in order to facilitate said installation and minimize, as much as possible, the increase in mass related to adding the sensors.

Two particularly restrictive aspects of this installation relate, on one hand, to the transmission of data between the sensors and the electronic unit for processing said data, that is generally connected to the electronic control system of the aircraft, and on the other hand, to the electrical supply of said sensors. The means implemented for both data transmission and supplying electrical power to the sensors must be relatively lightweight, unobtrusive, reliable and, in addition, must require a relatively low amount of maintenance. Of course, a transmission of data by radio-electric waves and a battery power supply are envisaged, but they do not satisfy all of the constraints mentioned above.

In fact, the ARING 664 (or AFDX) standard has been adopted for data transmissions on aircraft. Implementing this standard relies on a wired link comprising a shielded differential double pair cable capable of transporting two opposite data streams (commonly referred to as Tx and Rx) at a bit rate of 125 Mbit/s.

Also known, in particular, from document FR-A-3049790, is a data link system authorising power a supply by carrier current such that a power supply signal circulates on the Same cable as the data signal.

One of the difficulties encountered is preventing the power supply signal from disturbing the data signal.

### AIM OF THE INVENTION

A particular aim of the invention is to provide a linking system between two electronic devices, that allows a common transport of a data signal and a power supply signal by limiting the risk of disturbance(s) of the first signal by the second signal.

### SUMMARY OF THE INVENTION

For this purpose, a power and data transmission device is provided, comprising a first circuit, a second circuit and a cable connecting the first circuit and the second circuit and comprising a first pair and a second pair of electrical conductors for transmitting a data signal and a power signal, the data signal being transmitted in differential mode in a first direction on the first pair of electrical conductors and in a second direction on the second pair of electrical conductors. According to the invention, the first circuit is arranged to transmit, in differential mode, the power signal on a sinusoidal carrier using the common modes of the two pairs of conductors, and the second circuit is arranged to receive said power signal by maintaining, with respect to the cable, an actual impedance equal to an iterative impedance of the cable.

The use of a sinusoidal carrier makes it possible to ensure the optimal coexistence of any data signals and power signals on the same cable. Such a cable is characterised, in the same way as a conventional coaxial connection, by having an iterative impedance, i.e., a real impedance that is replicated step by step along its entire length. An iterative impedance line, when it is charged by a resistance equal in value to its iterative impedance (often referred to as characteristic impedance), has, at its input, a real impedance equal to the resistance charging it at its end, regardless of the length of the line. When a line with iterative impedance is charged by its characteristic impedance, signals travel along the line without causing any echoes (local over-voltages and/or over-currents) which be conducive to parasitic coupling. Thus, adapting the line according to its iterative or characteristic impedance makes it possible to prevent stationary waves from forming on the alternating wave of the power signal: such stationary waves would lead to anti-nodes or nodes of current or voltage, and would be likely to increase parasitic coupling between common-mode power transmission and differential-mode data transmission. There is thus effective segregation between power signals and data signals. For this purpose, the second circuit is arranged to charge the cable to a constant pure resistance even though the charge is variable. The transmission of power in sinusoidal voltage and current makes it possible to limit their bandwidth and thus limit high-frequency couplings. Preferably also, the carrier of the power signal is centred on a much lower frequency than that of the data bitstreams. Segregation via filtering is then facilitated.

Preferably, the first circuit comprises a first transformer connected to the first pair of electrical conductors, a second transformer connected to the second pair of electrical conductors, and a third transformer, in common mode, on the two pairs of electrical conductors; and/or the second circuit comprises a first transformer connected to the first pair of electrical conductors, a second transformer connected to the second pair of electrical conductors, and a third transformer, in common mode, on the two pairs of electrical conductors.

This provides galvanic insulation that, combined with AC power transmission, makes it possible to protect all of or part of the circuit from lightning and bulk current injection (BCI). The device then benefits from resistance to both and BCI without requiring specific protection components which are expensive, bulky and difficult to test; while minimizing interface cabling and guaranteeing a minimized bit error rate.

Advantageously, the first circuit is arranged so that the power signal has an alternating voltage having a high frequency, preferably in the megahertz range.

According to the additional features, used individually or all or some in combination:
the second circuit comprises an AC/DC converter receiving, as input, the power signal and providing, as output, a DC power signal having a rectified voltage and an electronic charge arranged to be proportional to the rectified voltage.
the AC/DC converter is associated with a filter arranged to attenuate any switching noises from the AC/DC converter;
the filter comprises a common-mode mutual inductor;
the electronic charge comprises a current generator that monitors the rectified voltage and is connected to the output of the AC/DC converter;
a low-pass filter Pi is arranged at the output of the current generator and matched to the iterative impedance of the cable;
the second circuit comprises a Zener diode voltage regulator;
the second circuit comprises a linear regulator with low drop-out (LDO).

The electronic charge circuit is an advantageous means of providing the power transmission line with a constant and real charge in order to avoid creating stationary waves or current distortions (because this corresponds to a widening of the frequency spectrum of the current and thus creates crosstalk with the transmission of data).

The invention also relates to an aircraft equipped with such a remote link device for connecting an electronic data processing unit to a sensor.

Other features and advantages of the invention will become apparent on reading the following description of particular and non-limiting embodiments of the invention.

### BRIEF DESCRIPTION OF THE DRAWINGS

Reference will be made to the accompanying drawings, among which:

FIG. 1 is an overall view of the circuit of the transmission device according to the invention;

FIG. 2 is an overall view of the first circuit of the transmission device;

FIG. 3 is an overall view of the circuit of the second circuit of the device of this transmission device, according to a first embodiment of the invention;

FIG. 4 is a partial view of the second circuit according to a variant of the first embodiment of the invention;

FIG. 5 is an overall view of the second circuit of this transmission device, according to a second embodiment of the invention.

### DETAILED DESCRIPTION OF THE INVENTION

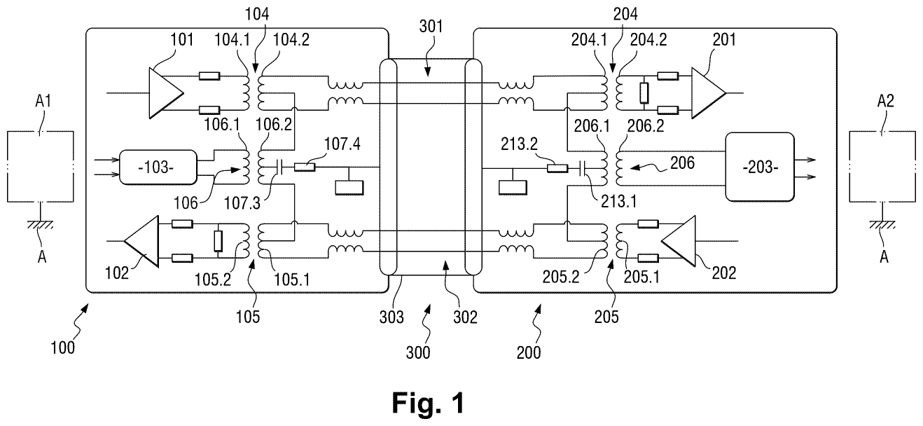

With reference to FIG. 1, the transmission device of the invention comprises a first circuit 100, a second circuit 200 and a cable 300 providing a link between the first circuit 100 and the second circuit 200. According to a typical application of the invention, the first circuit 100 is arranged to be connected to a first electronic device, for example, a data processing computer, and the second circuit 200 is arranged to be connected to a second electronic device, for example, a detector providing measurement data of any physical parameter.

The cable 300, in this case, ‘QUADRAX’, is standard and comprises a first pair 301 of electrical conductors and a second pair 302 of electrical conductors. In a manner known per se, the pairs are twisted and arranged in quadrature in a shield 303.

The first circuit comprises an input 101 of the data to be transmitted, an output 102 of the data received, and a power supply 103 receiving an input DC power signal provided, for example, by the first device or a power distribution network.

The input 101 is connected to the terminals of a primary winding 104.1 of a first transformer 104 having a secondary winding 104.2 to the terminals of which the electrical conductors of the first pair 301 of the cable 300 are connected.

The output 102 is connected to the terminals of a secondary winding 105.2 of a second transformer 105 having a primary winding 105.1 to the terminals of which the electrical conductors of the second pair 302 of the cable 300 are connected.

The power supply 103 is connected to the terminals of a primary winding 106.1 of a third transformer 106 having a secondary winding 106.2 having a first terminal connected to the mid-point of the secondary winding 104.2, a second terminal connected to the mid-point of the primary winding 105.1, and a mid-point connected to the mechanical ground of the first circuit 100 and/or the first device and to the shield 303 of the cable 300 (this mechanical ground constitutes the potential reference for the first device and the first circuit 100). The power supply 103 comprises a DC/AC converter arranged to convert the input DC power signal into a sinusoidal AC power signal having a frequency in the megahertz range and, more particularly, equal to, in this case, 1 MHz.

The second circuit comprises an output 201 of data received from the first device, an input 202 of data to be transmitted to the first device, and a power supply 203 providing a continuous output power signal to the second device.

The output 201 is connected to the terminals of a secondary winding 204.2 of a first transformer 204 having a primary winding 204.1 to the terminals of which the electrical conductors of the first pair 301 of the cable 300 are connected. A line Tx is thus formed between the input 101 and the output 201.

The input 202 is connected to the terminals of a primary winding 205. 1 of a second transformer 205 having a secondary winding 205.2 to the terminals of which the electrical conductors of the second pair 302 of the cable 300 are connected. A line Rx is thus formed between the input 202 and the output 102.

The power supply 203 is connected to the terminals of a secondary winding 206.2 of a third transformer 206 having a primary winding 206.1 having a first terminal connected to the mid-point of the primary winding 204.1, a second terminal connected to the mid-point of the secondary winding 205.2, and a mid-point connected to the mechanical ground of the second circuit 200 and/or the second device and to the shield 303 of the cable 300 (this mechanical ground constitutes the potential reference for the second device and the second circuit 200) via a capacitor 213.1 and a resistor 213.2. The 203 power supply comprises an AC/DC converter arranged to convert the alternating current power signal received at the input into a direct current power signal at the output that is suitable for powering the second device.

It is understood that an integral galvanic insulation solution is thus available, both in the form of direct current and high-frequency alternating current, that makes it possible to protect the second device from impacts, for example, over-voltage(s) and/or massive current injection(s) (lightning and BCI). It is thus not necessary to resort to protective components, such as over-voltage suppressors, which are difficult to monitor both during manufacture and during operation.

The data transmission part is performed conventionally and is not described further, in this case Attention is thus given in the remainder of the description only to the power part.

The power supply 103 preferably comprises a sinusoidal voltage generator having a frequency of approximately 1 MHz and an angular phase shift (cosine PHI) equal to 1. This sinusoidal voltage generator is arranged to transmit each of its phases in common mode on the pair of electrical conductors 301 of the line Tx and on the pair of electrical conductors 302 of the line Rx, respectively.

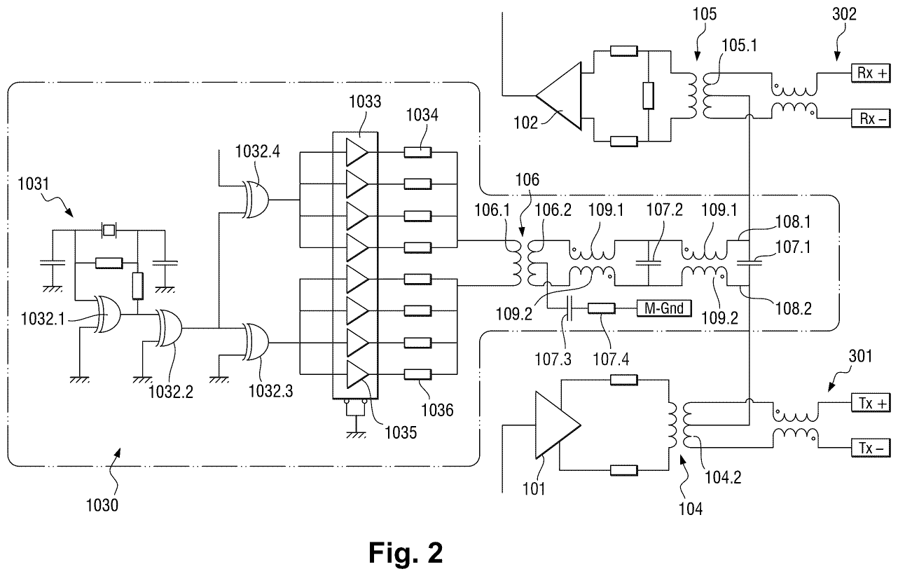

An example of a sinusoidal voltage generator 1030 is shown in FIG. 2. With reference to FIG. 2, the sinusoidal voltage generator 1030 comprises a crystal oscillator 1031 having a first terminal connected to a first input of a first XOR gate 1032.1 and a second terminal connected to an output of the first XOR gate 1032.1. The output of the output of the first XOR gate 1032.1 is connected to a first input of a second XOR gate 1032.2 that has an output connected to a first input of an output of the third XOR gate 1032.3 and to the first input of a fourth XOR gate 1032.4. The XOR gates 1032.1, 103.2 and 103.3 have second inputs connected to earth and the fourth XOR gate 1032.4 has a second input receiving the input DC power signal. The fourth XOR gate 1032.4 has an output connected to four amplifiers 1033 each having an output connected via a resistor 1034 to the positive terminal of the primary winding 103.1 and the third XOR gate 1032.3 has an output connected to four amplifiers 1035 each having an output connected via a resistor 1036 to the negative terminal of the primary winding 106.1. The XOR gates 1032 are thus integrated into a so-called quartz oscillator and phase shifter assembly. The amplifiers 1033 and 1035 belong, for example, to a digital buffer whose currents are distributed thanks to the resistors 1034, 1036 ensuring protection against short circuits in the link between the first circuit 100 and the second circuit 200.

The connection of the primary winding 105.1 and the secondary winding 104.2 to the secondary winding 106.2 will be set out in detail. The mid-point of the primary transformer 105.1 is connected to a first terminal of a first capacitor 107. 1 having a second terminal connected to the mid-point of the secondary transformer 104.2. The secondary winding 106.2 has a first terminal connected to the first terminal of the capacitor 107.1 by a first line 108.1 and a second terminal connected to the second terminal of the capacitor by a second line 108.2. The first line 108.1 comprises two coils 109.1 in series which are polarized in the same way, and the second line 108.2 comprises two coils 109.2 in series which are polarized in the opposite way to the coils 109.1. Each coil 109.1, 109.2 thus has its own inductor and each pair of facing coils 109.1, 109.2 has a mutual inductor. A second capacitor 107.2 extends between the connecting point of coils 109.1 to each other and the connecting point of coils 109.2 to each other. The mid-point of the secondary winding 106.2 is connected to the mechanical ground M-Gnd via a third capacitor 107.3 and a resistor 107.4 to perform an in-line adaptation in common mode. This forms a fourth-order LC low-pass filter with low loss due to the absence of resistive components, ensuring the elimination of high-frequency components from the sinusoidal signal that is transmitted with each potential on the common mode of one of the pairs 301, 302 and with the common-mode DC component.

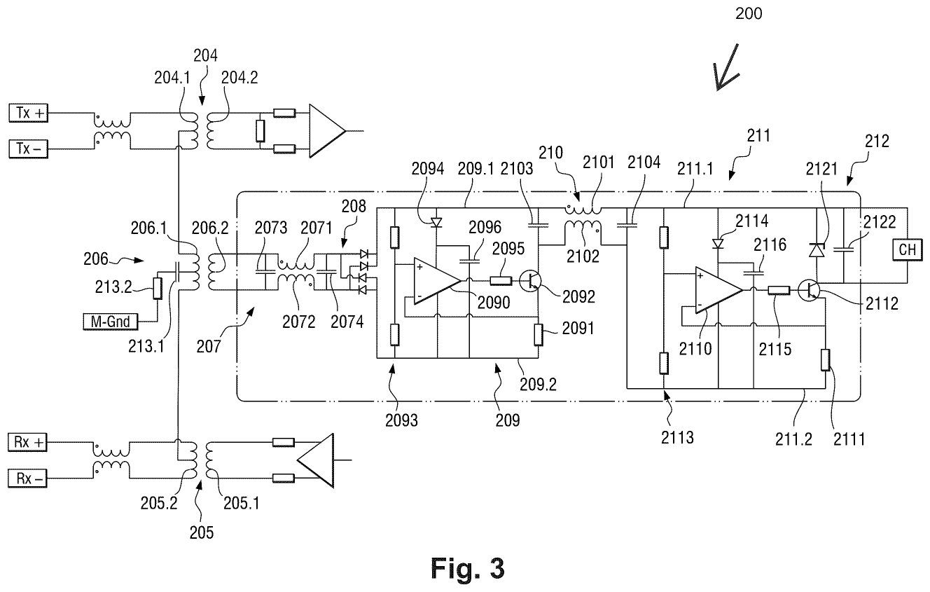

The second circuit 200, in a first embodiment, will be described in relation to FIG. 3.

The first stage comprises a filter 207 and a rectifier bridge 208. The filter 207 is a Pi-shaped LC filter that comprises a pair of coils 2071, 2072, with opposing polarizations and which face each other, each having its own inductor and jointly having mutual inductance, each having a first terminal connected to one of the terminals of the secondary winding 206.2 and a second terminal connected to one of the input terminals of the rectifier bridge 208. A first capacitor 2073 connects together the first terminals of the coils 2071, 2072, and a second capacitor 2074 connects together the second terminals of the coils 2071, 2072. In this case, the rectifier bridge 208 is a conventional full-wave rectifier bridge, in this case, of the GRAETZ type. The filter 207 is an analogue circuit that pre-filters to attenuate switching any switching noises from the rectifier bridge 208. It is understood that the first stage converts the AC power signal into a DC power signal having a full-wave rectified voltage equal to the average of the sinusoidal voltage.

The second stage is arranged to form a current consumer 209 that monitors the rectified voltage and comprises a first line 209.1 and a second line 209.2 which each extend from one of the output terminals of the rectifier bridge 208 to one of the input terminals of the third stage. The second line comprises, in series, a resistor 2091 and a transistor 2092, of the NPN type, having an emitter connected to the resistor 2091 and a collector connected, as previously indicated, to one of the input terminals of the third stage. The second stage also comprises an operational amplifier 2090 having a positive input connected to a voltage divider 2093 connecting the lines 209.1 and 209.2, a negative input connected to the second line 209.2 between the resistor 2091 and the transistor 2092, a positive supply terminal connected to the cathode of a diode 2094 having an anode connected to the first line 209.1, a negative supply terminal connected to the second line 209.2, and an output connected via a resistor 2095 to a base of the transistor 2092. A capacitor 2096 further connects the cathode of the diode 2094 to the second line 209.2. The second stage constitutes an electronic charge making it possible to simulate a resistive behaviour of the charge by forming a current-dependent consumer on the waveform of the full-wave rectified voltage. The second stage thus makes it possible for the cable 300 to ‘see’ a constant charge.

The third stage comprises a Pi-shaped LC filter 210 analogous to the filter 207. The filter 210 comprises a pair of coils 2101, 2102, with opposing polarizations and which face each other, each having its own inductance and jointly having mutual inductance. The first coil 2101 comprises a first terminal connected to the first line 209.1 of the second stage and a second terminal connected to a first line 211.1 of the fourth stage. The second coil 2102 comprises a first terminal connected to the second line 209.2 of the second stage and a second terminal connected to a second line 211.2 of the fourth stage. A first capacitor 2103 connects together the first terminals of the coils 2101, 2102, and a second capacitor 2104 connects together the second terminals of the coils 2101, 2102. It is understood that the filter 210 makes it possible to extract the resulting average voltage.

The fourth stage forms a charge proportional to the rectified voltage received at the input and thus a current-dependent consumer on the DC voltage received to provide a constant voltage to the second device (i.e., the user charge). The fourth stage comprises a current generator 211 analogous to the current consumer 209. The first line 211.1 and the second line 211.2 are connected, opposite to the third stage, to a voltage regulator 212, that comprises, in parallel, a component of the Zener diode type 2121 and a capacitor 2122, and, that is connected to the second device. The second line 211.2 comprises, in series, a resistor 2111 and a transistor 2112, of the NPN type, having an emitter connected to the resistor 2111 and a collector connected, as previously indicated, to the voltage regulator 212. The fourth stage also comprises an operational amplifier 2110 having a positive input connected to a voltage divider 2113 connecting the lines 211.1 and 211.2, a negative input connected to the second line 211.2 between the resistor 2111 and the transistor 2112, a positive supply terminal connected to the cathode of a diode 2114 having an anode connected to the first line 211.1, a negative supply terminal connected to the second line 211.2, and an output connected via a resistor 2115 to a base of the transistor 2112. A capacitor 2116 further connects the cathode of the diode 2114 to the second line 211.2. The voltage regulator 212 makes it possible to desensitize the device to variations in charge. The current consumed thus varies in a small proportion, depending on the variation of the input voltage received. This current flows through the equivalent of a Zener diode, across the terminals of which there is a constant voltage regardless of the current that flows through it.

The second circuit thus consumes a voltage similar to the reference voltage to keep the charge ‘seen’ by the cable at a constant level. For example, the cable is charged by the second circuit at 100 real ohms (i=u/r), for example. It is understood that the rectified voltage equal to the average of the sinusoidal voltage received at the input is used as a reference voltage for the current generators.

Preferably, the transformers and the coupled inductors are made using PCB technology, i.e., by embedding the cores in the PCB plates and by making the coils using conductive tracks, because this technology guarantees reproducible electrical performance and symmetries, such as common-mode rejection, is greatly improved. For example, this technology is known from the documents FR-A-2201553 and FR-A-3110780.

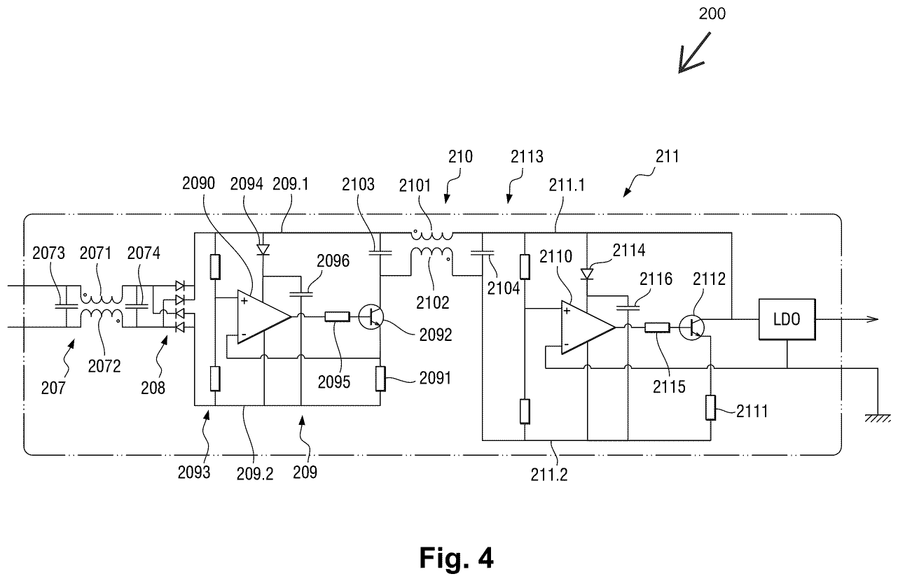

In the variant shown in FIG. 4, the voltage regulator 212 is replaced by a linear voltage regulator with low voltage drop-out or LDO that is also connected to the ground.

The LDO voltage regulator is an analogue ‘series’ voltage regulator capable of operating with a very low voltage drop-out between its input and its output. In addition, it restores a more precise voltage at the output and it is often easier to adjust the output voltage by simply changing the values of resistors which are not shown in the figure.

It is then possible to use a third-order (rather than a fourth-order) low-pass filter 207 LC in the first stage, as its role is simply to limit the feedback of switching noise from the diodes of the rectifier bridge 208 into cable 300.

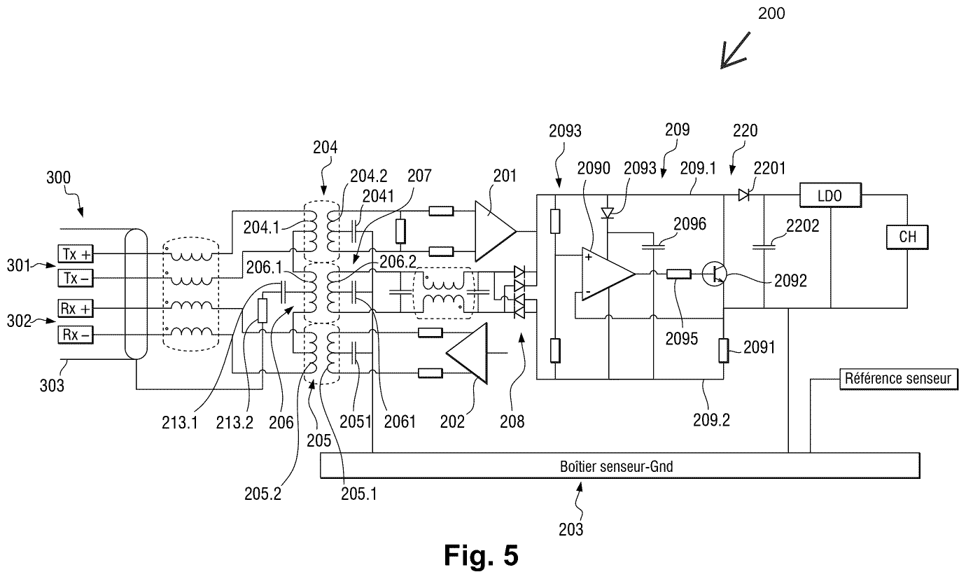

The second circuit 200, in a second embodiment, will be described in relation to FIG. 5. The second circuit 200 also comprises four stages. The first stage and the second stage are identical to those of the above variant.

The second circuit 200 according to the second embodiment differs from the variant of the first embodiment, firstly in that the windings 204.2, 206.2 and 205.1 have mid-points connected via capacitors 2041, 2061 and 2051 to the mechanical ground of the sensor housing-Gnd of the second circuit 200 and of the second device.

The second circuit 200 according to the second embodiment differs from the variant of the first embodiment, secondly in that the current generator 211 is eliminated and is replaced by a voltage recovery circuit 220. The voltage recovery circuit 220 comprises a diode 2201 having an anode connected to the first line 209.1 and to the collector of the NPN transistor 2092 and a cathode connected to the voltage regulator LDO. The voltage recovery circuit 220 also comprises a capacitor 2202 having a first terminal connected to the cathode of the diode 2021 and to a first branch of the LDO voltage regulator and a second terminal connected to a second branch of the LDO voltage regulator and to mechanical ground.

The diode 2021, capacitor 2022 and LDO voltage regulator assembly form a variable charge stage to provide the second device with a constant voltage. The consumption is variable such that the sum of the current at the emitter of the transistor 2092 and the second branch of the LDO is the same as at the positive input of the amplifier 2090. The transistor 2092 is used as an adjustment variable for the consumption of the second circuit 200, provided that no voltage is present at the negative input of the amplifier 2090. It must be noted that the consumption via the diode 2093 is very low, and this has very little influence on the overall consumption of the second circuit 200.

The electromagnetic compatibility with respect to massive current injections resulting from high-frequency pulses such as radar, which produce common-mode disturbances, is achieved by line symmetry, connecting to mechanical ground and connecting the double inductance in differential mode. The capacitor 2061 further eliminates the common-mode disturbances.

The four-pole common-mode inductor of the coils 2071 and 2072 applies to the entire four-wire line in order to provide high impedance to high-frequency common-mode parasitic signals. The transformers 204, 205, 206 are responsible for the DC and low-frequency insulation. The PCB technology makes the system highly symmetrical, so at the series resonance of this assembly (approximately 100 MHz), the currents are balanced, opposite and flow almost entirely towards the shielding 303 of the cable 300 via the resistor 213.2. The value of the resistor 213.2 is equal to the characteristic impedance value of the cable 300 in common mode, between 50 ohms and 100 ohms, in order not to create any stationary waves likely to increase the common-mode currents or voltages in certain parts of the cable, and thus to create disturbances on the useful signals by inadequate common-mode rejection.

The common-mode residual voltages are all transmitted to the equipotential of the mechanical ground, itself connected to the structure close to the carrier. Thus, lightning and BCI currents cannot create dangerous differential voltages for the electronics of this sensor. For this purpose, the capacitors 2041, 2051 and 2061 have a low impedance with respect to the high-frequency common-mode voltages exacerbated during the resonance of the LC series pairs formed by:

the common-mode inductor of the coils 2071 and 2072 and the transformer 204;
the common-mode inductor of the coils 2071 and 2072 and the transformer 205;
the common-mode inductor of the coils 2071 and 2072 and the transformer 206.

Thus, the high-frequency currents are mainly looped back to the proximity potential reference of the second device. This results in a common-mode high-frequency voltage, applied to the electronics of the second device, that is completely minimized and thus has no impact on the operation of the second device.

The invention may be used, in particular, in an aircraft A comprising a data processing device Al connected to the first circuit 100 of the device of the invention and at least one sensor A2 connected to the second circuit 200 of this device.

Of course, the invention is not limited to the embodiments described, but covers any variant included within the scope of the invention as defined by the claims.

In particular, any sinusoidal signal generator may be used as a current generator. The sinusoidal signal generator may furthermore be arranged to provide a signal having a frequency other than 1 MHz.

The structure described is particularly straightforward. Indeed, the sinusoidal signal received must be loaded by a ‘real’ resistance equal to the characteristic impedance of the line (approximately 100 ohms in the case of the Quadrax cable) and the power to be transmitted is low, in the Watt range: to keep the system as straightforward as possible, in this case, a purely analogue solution is preferred, despite its low output. However, a solution based on digital components may be envisaged.

This solution is also advantageous because many components which may be used to implement it are easily available commercially.

The invention is applicable to any type of installation, fixed or mobile, and to any vehicle.

1. A power and data transmission device, comprising a first circuit, a second circuit and a cable connecting the first circuit and the second circuit and comprising a first pair and a second pair of electrical conductors for transmitting a data signal and a power signal, the data signal being transmitted in differential mode in a first direction on the first pair of electrical conductors and in a second direction on the second pair of electrical conductors; characterized in that the first circuit is designed to transmit, in differential mode, the power signal on a sinusoidal carrier using the common modes of the two pairs of conductors and the second circuit is designed to receive said power signal while maintaining, with respect to the cable, a real impedance equal to an iterative impedance of the cable.

2. The device according to claim 1, wherein the first circuit comprises a first transformer connected to the first pair of electrical conductors, a second transformer connected to the second pair of electrical conductors, and a third transformer in common mode on the two pairs of electrical conductors.

3. The device according to claim 1, wherein the second circuit comprises a first transformer connected to the first pair of electrical conductors, a second transformer connected to the second pair of electrical conductors, and a third transformer in common mode on the two pairs of electrical conductors.

4. The device according to claim 1, wherein the first circuit is arranged so that the power signal has an alternating voltage having a high frequency, preferably in the megahertz range.

5. The device according to claim 1, wherein the second circuit comprises:
an AC/DC converter receiving the power signal as input, and providing a DC power signal with a rectified voltage as output;
an electronic charge arranged to be proportional to the rectified voltage.

6. The device according to claim 5, wherein the AC/DC converter is associated with a filter arranged to attenuate any switching noises from the AC/DC converter.

7. The device according to claim 6, wherein the filter comprises a common-mode mutual inductor.

8. The device according to claim 5, wherein the electronic charge comprises a current consumer that monitors the rectified voltage and is connected to the output of the AC/DC converter.

9. The device according to claim 8, comprising a low-pass filter Pi arranged at the output of the current consumer and matched to the iterative impedance of the cable.

10. The device according to claim 5, wherein the second circuit comprises a Zener diode voltage regulator.

11. The device according to claim 5, wherein the second circuit comprises a linear voltage regulator with low drop-out (LDO).

12. An aircraft comprising a data processing device connected to the first circuit of a device according to claim 1 and at least one sensor connected to the second circuit of this device.
